(19) United States
(12) Patent Application Publication
(10) Pub. No.: US 2008/0062035 A1
(43) Pub. Date: Mar. 13, 2008

(54) IR CONVERTER

(76) Inventor: KIRBY GOEDDE, Morristown, IN (US)

Correspondence Address: SHIMOKAJI & ASSOCIATES, P.C., 8911 RESEARCH DRIVE, IRVINE, CA, 92618, US

(21) Appl. No.: 11/854,494

(22) Filed: Sep. 12, 2007

Related U.S. Application Data
(60) Provisional application No. 60/825,312, filed on Sep. 12, 2006.

(51) Int. Cl. G08C 19/16; H04L 17/02

(52) U.S. Cl. 341/176

(57) ABSTRACT

A television may be configured with a software permitting the television to be controlled by a plurality of brands of remote controls. In particular, the present invention allows replacing hospital televisions with replacement televisions equipped with the present invention regardless of the brand of the replacement television. The present invention may allow a hospital pillow speaker to be used with the replacement television, even if the replacement television is of a different brand from the pillow speaker.

### CROSS-REFERENCE TO RELATED APPLICATIONS

This application claims foreign priority under 35 USC 119(a)-(d) to Chinese Patent Application 2007xxxxxxx, filed on Sep. 5, 2007, the disclosure of which is herein incorporated by reference in its entirety. This application further claims the benefit under 36 USC 119(e) to U.S. provisional patent application 60/825,312, filed Sep. 12, 2006, the disclosure of which is herein incorporated by reference in its entirety.

### BACKGROUND OF THE INVENTION

The present invention relates to apparatus and methods for adding IR recognition to an appliance and, more particularly to apparatus and methods for permitting various brands of televisions to recognize IR codes from a user interface.

When replacing televisions at a hospital, one issue is the need to match the television brand with the hospital pillow speaker. This may require the hospital to purchase a single specific brand of television in order to use the same pillow speaker.

Referring to FIG. 1, there is shown a conventional hospital pillow speaker 10. The pillow speaker 10 may include a wire 12 that may plug into the television (not shown). The pillow speaker 10 may include a keypad 14 for changing channels and a speaker 16 for listening to the sound from the television. The keypad 14 sends wired infrared (IR) codes to the television to change channels, volume, etc. These wired IR codes are vendor specific. RCA has their own IR codes, Zenith has there own IR codes, PDI has their own IR codes, Phillips has their own IR codes, and the like.

As long as the hospital replaces current televisions with the same brand, the pillow speaker 10 can be reused. Pillow speakers 10 may be expensive to replace and therefore the hospital generally must purchase replacement televisions that are of the same brand in order to recognize IR codes from the pillow speaker 10 and to avoid extra expense of also replacing the pillow speakers 10 that may otherwise be functional.

U.S. Pat. No. 6,097,520, issued to Kadnier, describes a system for the detection of user-selected remote control commands from virtually any appliance remote control. The system of Kadnier receives IR commands from an infrared remote control and generates control pulses for controlling a computer that acts as a universal IR receiver. The system of Kadnier uses a learn mode in which the user enters a user-selected remote control button sequence which is detected and stored. The user then selects a command on the receiving device (a computer) to be associated with this remote control button sequence. Therefore, the buttons of a remote need to be learned by the receiving device.

As can be seen, there is a need for improved apparatus and methods for allowing a user interface, such as a hospital pillow speaker, to be usable with a variety of brands of televisions, without requiring reprogramming of the user interface when changing television brands.

### SUMMARY OF THE INVENTION

In one aspect of the present invention, an appliance comprises a user interface sending a code to the appliance; and a software recognizing branded codes from a plurality of brands of user interfaces.

In another aspect of the present invention a method for permitting a plurality of brands of user interfaces to operate an appliance comprises receiving codes from the user interface; interpreting the codes by the appliance; and controlling the appliance based on the interpreted codes.

According to a further aspect of the present invention, a software comprises a code sequence for receiving IR codes from a user interface; a code sequence for interpreting branded IR codes from a plurality of brands of user interface; and a code sequence for controlling an appliance based on the interpreted IR codes.

These and other features, aspects and advantages of the present invention will become better understood with reference to the following drawings, description and claims.

### BRIEF DESCRIPTION OF THE DRAWINGS

FIG. 1 is a perspective view of a pillow speaker of the prior art;

FIG. 2 is a block diagram showing a television incorporating the IR converter of the present invention; and

FIG. 3 is a flow chart describing a method for permitting a user interface to operate an appliance according to the present invention.

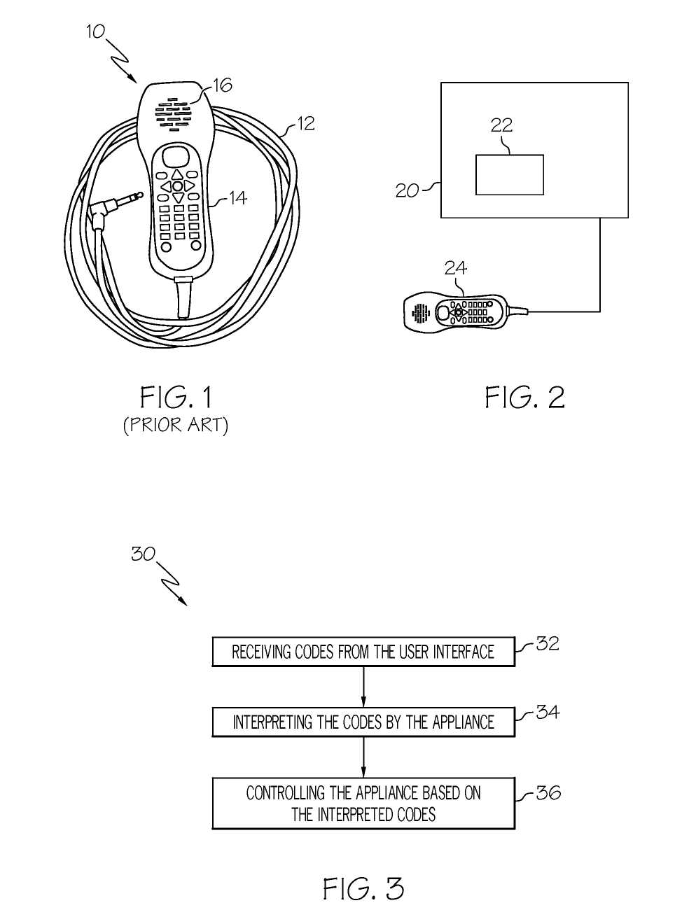

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

The term “appliance” as used herein may refer to any electronic equipment operated by a user interface. An appliance may include a television, VCR, DVD player/recorder, surround sound system, digital cable systems, a digital television recorder, a video recorder, a television set-top box and the like.

The term “user interface” (UI) as used herein may refer to an interface between an appliance and the user in which the user may select and/or adjust certain features of the appliance. A hospital pillow speaker, as described below, may be one example of a user interface.

Broadly, the present invention provides apparatus and methods for allowing a user interface, such as a hospital pillow speaker, to be usable with a variety of brands of televisions, without requiring reprogramming of the user interface when changing television brands. Unlike conventional pillow speakers that must be matched with a particular brand of replacement television, the present invention allows a variety of brands of televisions to be used with the original hospital pillow speaker.

Referring to FIG. 2, the present invention may add IR recognition for different television brands within the television software. Therefore, the television 20, having revised software 22 according to the present invention, may accept IR codes from a variety of different user interfaces, including a variety of hospital pillow speakers 24. According to one embodiment of the present invention, multiple pillow speakers 24 may control the same television 20. These multiple pillow speakers 24 may be of multiple brands. This embodiment may be practical in a shared hospital room where patients in multiple beds may be set up to watch a shared television.

One embodiment of the present invention may include software 22 having a code sequence for receiving IR codes from a user interface. The software 22 may have a further code sequence for interpreting branded IR codes from a variety of brands of user interface. Finally, the software 22 may have a code sequence for controlling the television based on the interpreted IR codes. For example, if a Zenith pillow speaker is used to control an RCA television, the RCA television, equipped according to the present invention, may have software for interpreting a user selected function from the pillow speaker, such as a command to increase the volume of the television.

Referring to FIG. 3, there is shown a method 30 for permitting a user interface (e.g., a hospital pillow speaker 24) to operate an appliance (e.g., television 20). The method 30 may include a step 32 of receiving IR codes from the user interface. The IR codes may be conventional IR codes as is well known in the art. The IR codes may be infrared wavelength-based signals or any other conventional signals, such as radio-frequency-based signals, used to control an appliance with a user interface. The method 30 may include a step 34 for interpreting the IR codes with software (e.g., software 22) of the appliance. Finally, the method 30 may include a step 36 for controlling the television based on the interpreted IR codes. The interpretation of the IR codes from the pillow speaker by the appliance may be done by any means known to one skilled in the art. For example, the software may contain a database of codes for a plurality of user interfaces. The software may recognize the brand of pillow speaker and interpret the IR code accordingly. Alternatively, the software may display a menu, wherein the user selects the brand of pillow speaker being used with the television. By making this selection, the television will recognize the brand of pillow speaker and, therefore, the associated IR codes.

For example, a user may press a button on a user interface for increasing the volume of the television. If the user has a Brand X user interface and a Brand Y television, typically the Brand Y television would not recognize the IR codes from the Brand X user interface. However, using the apparatus and methods of the present invention, the Brand Y television may be able to interpret the IR codes of the Brand X user interface, thereby allowing the volume of the television to be increased.

It should be understood, of course, that the foregoing relates to exemplary embodiments of the invention and that modifications may be made without departing from the spirit and scope of the invention as set forth in the following claims.

I claim:

1. An appliance comprising:
a user interface sending a code to the appliance; and
a software recognizing branded codes from a plurality of brands of user interfaces.

2. The appliance of claim 1 wherein the appliance is a television.

3. The appliance of claim 1 wherein the user interface is a wired remote control.

4. The appliance of claim 1 wherein the user interface is a hospital pillow speaker.

5. The appliance of claim 1 wherein the codes are IR codes.

6. A method for permitting a plurality of brands of user interfaces to operate an appliance, the method comprising:
receiving codes from a first user interface;
interpreting the codes; and
controlling the appliance based on the interpreted codes.

7. The method of claim 6 wherein:
the appliance is a television;
the user interface is a hospital pillow speaker; and
the codes are IR codes.

8. The method of claim 6 wherein a software is used to interpret the codes by the appliance.

9. The method of claim 8, wherein the software compares the codes received from the user interface, compares the received codes to a database of known codes, and controls the appliance based on the instructions for the code received as recovered from the database.

10. The method of claim 6 wherein the appliance is a first brand different from a second brand of the user interface.

11. The method of claim 10, further comprising sending codes to the appliance from a second brand of user interface, wherein the second brand is of a different brand than a first brand of the first user interface.

12. A software comprising:
a code sequence for receiving IR codes from a user interface;
a code sequence for interpreting branded IR codes from a plurality of brands of user interface; and
a code sequence for controlling an appliance based on the interpreted IR codes.

13. The software of claim 12 wherein the user interface is a hospital pillow speaker and the appliance is a television.

14. The software of claim 12 wherein the code sequence for interpreting branded IR codes from a plurality of brands of user interfaces permits interpreting branded IR codes from at least three brands of user interfaces.
